(19) United States
(12) Patent Application Publication
(10) Pub. No.: US 2021/0004907 A1
(43) Pub. Date: Jan. 7, 2021

(54) METHOD AND SYSTEM FOR MANAGING DORMANT ASSETS BASED ON MACHINE LEARNING

(71) Applicant: Bluevisor Systems, Busan (KR)

(72) Inventors: Yong Guk Hwang, Busan (KR); Geon Gi Im, Busan (KR); Byeong Il Han, Busan (KR)

(21) Appl. No.: 16/583,162

(22) Filed: Sep. 25, 2019

(30) Foreign Application Priority Data
Jul. 1, 2019 (KR) 10-2019-0078563
Aug. 30, 2019 (KR) 10-2019-0107041

(51) Int. Cl. G06Q 40/06; G06N 7/00; G06N 20/00

(52) U.S. Cl. CPC G06Q 40/06; G06N 20/00; G06N 7/005

(57) ABSTRACT

The present disclosure relates to a method and system for managing dormant assets based on machine learning. The method for managing dormant assets based on machine learning comprises performing a similarity search for past history of the assets based on the machine learning, determining a reference date for extracting a similar chart depending on a result of the similarity search and extracting the similar chart depending on the determined reference date and generating an expected chart model based on the similar chart. Using the method, it is possible to provide customized dormant asset management services similar to the existing WRAP accounts at low cost.

### CROSS-REFERENCE TO RELATED APPLICATION

This application claims priority from Korean Patent Application No. 10-2019-0078563 filed on Jul. 1, 2019 and Korean Patent Application No. 10-2019-0107041 filed on Aug. 30, 2019 in the Korean Intellectual Property Office, and all the benefits accruing therefrom under 35 U.S.C. 119, the contents of which in their entirety are herein incorporated by reference.

### BACKGROUND

### Field of the Disclosure

The present disclosure relates to a method and system for managing dormant assets. Specifically, it relates to a method and system for managing a user's dormant assets based on machine learning.

### Description of the Related Art

As the era of low interest rates continues, there is a growing interest in high-yield financial instruments that may expect higher returns than ordinary deposit rates. A representative example of such high-yield financial instruments is a fund that invests by constituting a portfolio based on stock items in the securities market.

However, existing fund had a high burden on the minimum amount to be invested, and the management and performance fee was also high, making it difficult for ordinary people with insufficient capital to use. In addition, such a fund had a problem of administering assets in a one-way manner according to an administering company's portfolio without considering the investment propensity of a customer.

The financial instrument that came out to solve this problem is a WRAP account service. The WRAP account is a financial instrument for comprehensive asset management, and the administering company provides customized services such as asset allocation and investment recommendation according to the customer's investment propensity. However, these WRAP accounts still have high investment minimums and high management and performance fees, making them difficult for the general public to use.

Meanwhile, it is recently announced that there are about 24 million unused dormant accounts and the amount of them reaches 1 trillion won. Most of these dormant accounts have a small amount, so customers do not know the existence of dormant accounts, or because they are uncomfortable even if they know them, they are often left unattended. An integrated inquiry service has appeared to make it easy to find the assets of dormant accounts. However, most dormant assets are small. Therefore, even if they find their assets, they cannot find an effective means to administer or invest. As a result, there are still not many people using the integrated inquiry service.

### SUMMARY

In some embodiments, a method for managing assets based on machine learning, wherein the method is performed by a computing device, the method comprises performing a similarity search for past history of the assets based on the machine learning, determining a reference date for extracting a similar chart depending on a result of the similarity search and extracting the similar chart depending on the determined reference date and generating an expected chart model based on the similar chart.

In some embodiments, a system for managing assets comprises a memory for storing one or more instructions and a process, wherein the process performs a similarity search for past history of the assets based on machine learning, determines a reference date for extracting a similar chart depending on a result of the similarity search, and extracts the similar chart depending on the determined reference date and generates an expected chart model based on the similar chart, by executing the stored one or more instructions.

### BRIEF DESCRIPTION OF THE DRAWINGS

FIG. 1 is a schematic diagram showing a system for managing dormant assets based on machine learning, according to some embodiments of the present disclosure.

FIG. 2 is a block diagram showing a detailed configuration of a server 100 illustrated in FIG. 1.

FIG. 3 is a flow chart showing a method for managing dormant assets based on machine learning, according to some embodiments of the present disclosure.

FIG. 4 is a flow chart further embodying the step of collecting and processing data, as shown in step S100 of FIG. 3.

FIG. 5 is a flow chart illustrating a method for scaling-up a cloud server in step S120 of FIG. 4.

FIG. 6 is a flow chart further embodying the step of sorting and processing by a data type, as shown in step S130 of FIG. 4.

FIG. 7 is a flow chart illustrating a method for scaling-down a cloud server in step S140 of FIG. 4.

FIG. 8 is a flow chart further illustrating the step of constituting an investment universe based on machine learning, as shown in step S200 of FIG. 3.

FIG. 9 is a flow chart further embodying the step of calculating an investment portfolio based on machine learning, as shown in step S300 of FIG. 3.

FIG. 10 is a flow chart further embodying the step of monitoring and rebalancing, as shown in step S400 of FIG. 3.

FIG. 11 is a flow chart exemplifying a method for managing dormant assets based on machine learning, according to some embodiments of the present disclosure.

FIGS. 12 and 13 illustrate an application UI used in a method for managing dormant assets based on machine learning, in accordance with some embodiments of the present disclosure.

20 is a flow chart for illustrating a method for customizing a layout in step S2400 of FIG. 8.

FIG. 14 is a hardware configuration diagram showing an example computing device that may implement a device according to various embodiments of the present disclosure.

### DETAILED DESCRIPTION OF THE EMBODIMENTS

Hereinafter, embodiments of the present disclosure will be described in detail with reference to the accompanying drawings. Benefits and features of the present disclosure, and methods for accomplishing the same will become apparent with reference to the embodiments described below in detail in conjunction with the accompanying drawings. However, the technical idea of the present disclosure is not limited to the following embodiments, but may be implemented in various forms. The following embodiments are merely provided to complete the technical teaching of the present disclosure, and to fully inform those skilled in the art of the present disclosure of the scope of the present disclosure. The technical teaching of the present disclosure is defined only by the scope of the claims.

In adding reference numerals to the components of the respective drawings, it should be noted that the same components are designated by the same reference numerals as much as possible even though they are shown in different drawings. Further, in describing the present disclosure, if it is determined that the detailed description of the related well-known configuration or function may obscure the subject matter of the present disclosure, the detailed description thereof will be omitted.

Unless otherwise defined, all terms (including technical and scientific terms) used in the present specification may be used in a sense that may be commonly understood by those skilled in the art to which the present disclosure belongs. In addition, the terms defined in the commonly used dictionaries are not ideally or excessively interpreted unless they are specifically defined clearly. The terms used herein are to describe embodiments and are not intended to limit the present disclosure. Herein, the singular also includes the plural unless specifically stated otherwise in the phrase.

In addition, in describing the components of the present disclosure, the terms such as first, second, A, B, (a), or (b) may be used. These terms are only to distinguish the components from other components, and the nature, order, or sequence of the components is not limited by the terms. When a component is described as being “linked,” “coupled,” or “connected” to other component, the component may be directly linked or connected to the other component. However, it is to be understood that another component may be “linked,” “coupled,” or “connected” between each component.

The terms “comprises” and/or “comprising” as used herein do not exclude the presence or addition of one or more other components, steps, operations, and/or elements mentioned.

Hereinafter, some embodiments of the present disclosure will be described in detail with reference to the accompanying drawings.

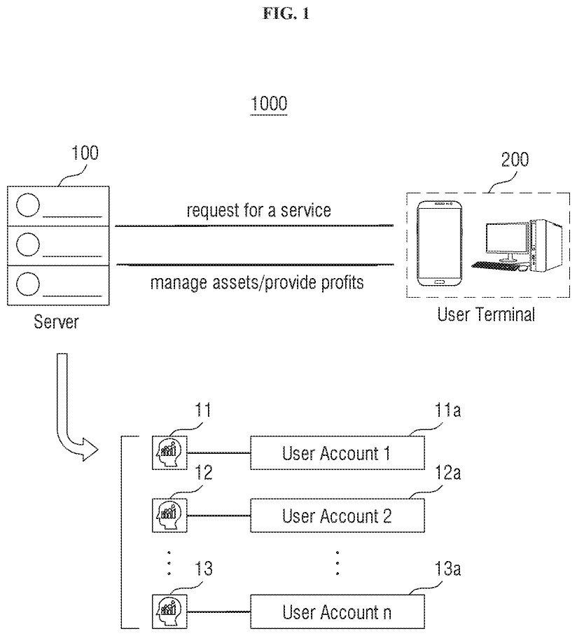

FIG. 1 is a schematic diagram showing a system for managing dormant assets based on machine learning, according to some embodiments of the present disclosure. As shown in FIG. 1, a system 1000 for managing dormant assets based on the machine learning may include a server 100 and a user terminal 200. However, this is one embodiment for achieving the object of the present disclosure. Naturally, some components may be added or deleted. For example, the user terminal 200 of FIG. 1 may be deleted in some circumstances. Hereinafter, each component will be briefly described.

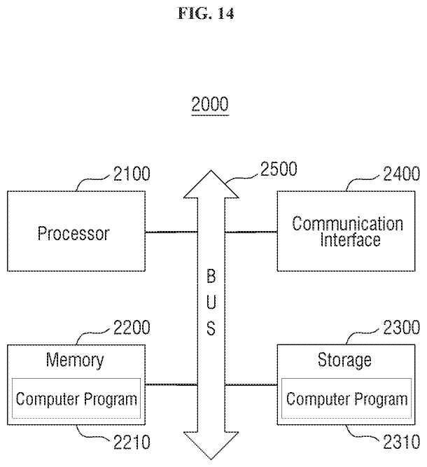

The server 100 provides an asset management service using a method for managing dormant assets based on the machine learning to a user according to a request of the user terminal 200. For example, the server 100 may be a computing device or system that is entrusted a user's dormant assets by the request of the user terminal 200 and makes a profit by investing or administering the entrusted assets in financial instruments. The server 100 may be comprised of one or more server devices (in other words, computing devices). Here, the computing devices may be a notebook, a desktop, a laptop, or the like, but are not limited thereto, and may include any kinds of devices equipped with a computing function and a communication function. Some examples of such computing devices are described in more detail with reference to FIG. 14.

The user terminal 200 is a client terminal used by a user to use a dormant assets management service provided by the server 100. The user terminal 200 may be provided with an application (APP) provided by the person who operates the server 100, and may communicate with the server 100 through the APP. The user may request the dormant assets management service according to the present disclosure through the APP, inquire a dormant account and dormant asset management status of the user, or change the user's investment propensity and related information. Here, the APP may refer to an application that may be executed on a smart device such as a smart phone or a smart TV.

The user terminal 200 may transmit a service request for requesting entrustment administration of the user's dormant assets to the server 100. In response to the service request, the server 100 provides an asset management service using the method for managing dormant assets based on the machine learning, and provides the user with administration profits according to the service.

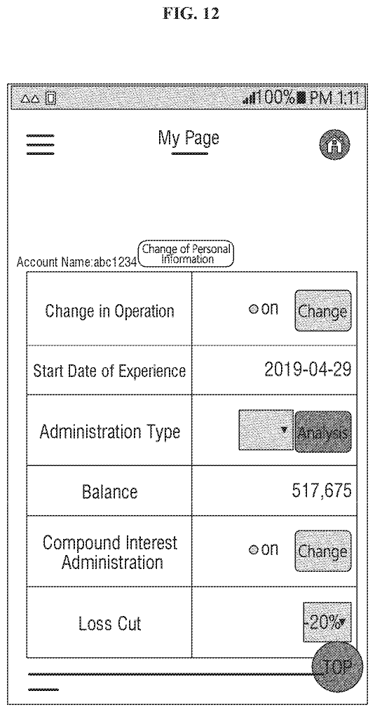

As will be described below with reference to FIG. 12, for the dormant asset management service provided by the server 100, the user terminal 200 may provide a user interface (UI) for allowing the user to check his/her dormant asset management state or investment status in real time. The user may monitor the management status of the dormant assets entrusted by the user through the user terminal 200, and may give feedback on it or adjust his/her investment propensity.

In an embodiment of the present disclosure, a system 1000 for managing dormant assets based on the machine learning inquires a user's dormant account with the user's consent, assigns Machine learning based wealth management platforms 11, 12, and 13 to the assets of the inquired dormant account, and performs an entrusted investment for the user. Then, it provides an investor with a management status of the user's dormant assets in real time.

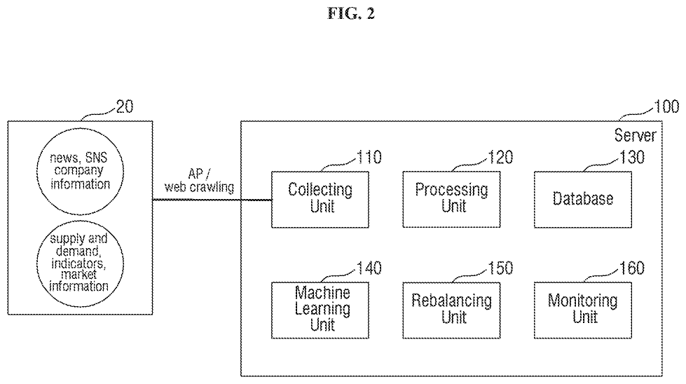

In the embodiment of the present disclosure, the server 100 may operate the Machine learning based wealth management platforms 11, 12, and 13 that are matched one-to-one to each of a plurality of dormant accounts 11a, 12a, and 13a entrusted by users. The Machine learning based wealth management platform 11, 12, and 13 include an artificial intelligence algorithm that learns financial big data collected based on the machine learning to distribute the assets of the dormant accounts 11a, 12a, and 13a according to a portfolio and to make investments. The Machine learning based wealth management platforms 11, 12, and 13 operate the assets of the dormant accounts 11a, 12a, and 13a by themselves according to the algorithm without human intervention. Therefore, it is economical because it does not take extra human cost. In addition, each of the dormant accounts 11a, 12a, and 13a is assigned a dedicated Machine learning based wealth management platform 11, 12, and 13 one-to-one. Therefore, it may provide customized investment services that are optimized for the investment situation or propensity of individual users. The Machine learning based wealth management platforms 11, 12, and 13 are algorithms that perform a method for managing dormant assets as described through some embodiments of the present disclosure, and it may include all or a part of a machine learning unit 140, a rebalancing unit 150, or a monitoring unit 160 as described later in FIG. 2.

Hereinafter, a detailed configuration and function of the server 100 will be described with reference to FIG. 2.

FIG. 2 is a block diagram showing a detailed configuration of a server 100 illustrated in FIG. 1. Referring to FIG. 2, the server 100 includes a collecting unit 110, a processing unit 120, a database 130, the machine learning unit 140, the rebalancing unit 150, and the monitoring unit 160. However, this is one embodiment constituting the server 100 to achieve the purpose of the present disclosure, some components may be added, deleted, or changed. For example, the database 130 may be replaced with a cloud-based data storage server. In this case, the physical configuration of the database 130 may not be included in the server 100 but may be included in an external server (not shown) that provides a cloud-based service. Hereinafter, each component will be described in detail with reference to the drawing.

The collecting unit 110 collects big data for the method for managing the dormant assets from the outside. For example, the collecting unit 110 may collect company information such as basic information of a company, financial statements, electronic disclosure information, equity information, or disclosure information provided by an authorized institution by using a web crawler, or may collect data from news, blogs, or social network services (hereafter, SNS) utilizing web mining technologies. Alternatively, the collecting unit 110 may collect market information such as securities indexes (e.g., KOSPI Index, KOSDAQ Index, NASDAQ Index, Dow Index, Shanghai Index, Hang Seng Index, Nikkei Index, or the like), exchange rate indicators, oil price indicators, trading trends by investor, transaction details, market cap of stocks, trading volume, trading value, or short selling status using open APIs in the markets where financial instruments are traded or open APIs of securities companies, or may collect other data, such as investment alerts, investment warnings, suspension of trading, capital increase, dividends, or capital decease for certain stocks. The company information, the market information, and other information or data collected through the collecting unit 110 are stored in the database 130.

The processor 120 processes the data collected through the collecting unit 110 into secondary data for use in dormant asset management. For example, the processor 120 may process numerical structured data of the collected data into the secondary data such as BPS (Book value Per Share), EPS (Earning Per Share), PER (Price Earning Ratio), PBR (Price Book value Ratio), ROE (Return On Equity), ROA (Return On Assets), RSI (Relative Strength Index), stochastics, moving average, market preference by theme, overall market indicator, market indicator by industry group, or volatility index.

Alternatively, the processing unit 120 may analyze non-numerical unstructured data of the collected data by using a SyntaxNex algorithm or a grab cut algorithm, or the like, and process them into the secondary data such as public expectations or fears about investment assets. The secondary data processed through the processing unit 120 is stored in the database 130.

The database 130 stores data collected by the collecting unit 110 or the secondary data processed by the processing unit 120. The database 130 may be a physical storage device embedded in the server 100, but may be a cloud database provided by an external cloud server (not shown). In this case, the server 100 performs data communication with the external cloud server and stores the collected and processed data in the database 130.

In an embodiment, the database 130 may be variably adjusted depending on the size of the storage capacity used by the server 100. For example, when the capacity of the data collected by the server 100 through the collecting unit 110 is larger than the remaining capacity of the database 130, the capacity of the database 130 may be expanded (scale-up) and adjusted to sufficiently store the collected data. Alternatively, when excess capacity occurs in the database 130 while the server 100 processes the collected data and converts the collected data into the secondary data, the capacity of the database 130 may be reduced (scale-down) to prevent it from taking up too many system resources.

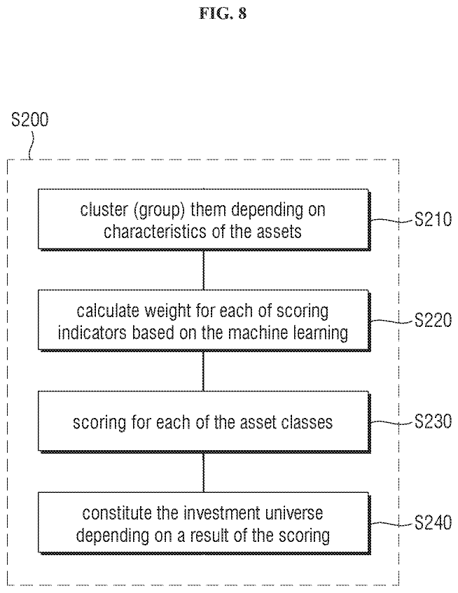

The machine learning unit 140 learns historical price information, chart information, indicator information, volatility information, relevance information such as market indicators or exchange rates, scoring information, or the like of investment assets (e.g. stocks, bonds, or commodities such as gold, silver, or oil), and constitutes an investment universe by scoring investment assets accordingly, based on the machine learning. Here, the investment universe means a set of investment candidates that will constitute an investment portfolio. The machine learning unit 140 extracts past dates most similar to current market conditions and price flows for investment assets within the investment universe, and generates an expected chart model based on a price chart associated with the extracted date (for example, a price chart for the next day of the extracted date), based on the machine learning. Then, it sets the expected buying and selling price, timing of buying and selling, and expected rate of return on investment assets according to the expected chart model, and calculates the risk for them. Further, it calculates an investment portfolio for the user account by referring to the investment propensity of the individual user along with the expected rate of return and risk. A detailed method that the machine learning unit 140 constitutes the investment universe and calculates the investment portfolio will be described below in more detail with reference to FIG. 8.

In an embodiment, various models may be used as an AI model of the machine learning unit 140. For example, the machine learning unit 140 may use convolutional neural networks (hereinafter, “CNN”) as its AI model. The CNN is a deep learning model that combines a neural network with filter technologies to optimize an artificial neural network to better understand the characteristics of input data.

Here, the artificial intelligence model of the machine learning unit 140 may include an artificial neural network having a graph structure consisting of a plurality of layers and a plurality of nodes constituting each layer, in which the plurality of layers may include one or more input layers, one or more hidden layers, and one or more output layers. The input layer means a layer that receives data to be analyzed/learned in the layer structure of the neural network, and the output layer means a layer in which a result value is output in the layer structure of the artificial neural network. The hidden layer means all layers except the input layer and the output layer in the layer structure of the artificial neural network. The neural network consists of a continuous layer of neurons, in which neurons in each layer are connected to neurons in the next layer. When the input layer and the output layer are directly connected without the hidden layer, each input contributes to the output independently of the other inputs, making it difficult to obtain accurate results. In practice, the input data are interdependent and combined to affect the output in a complex structure. Therefore, by adding the hidden layer, the neurons in the hidden layer capture subtle interactions between the inputs that affect the final output.

In an embodiment, the CNN model of the machine learning unit 140 may be implemented by a TensorFlow algorithm.

In an embodiment, the machine learning unit 140 may use the TensorFlow so as to determine one or more scoring indices to constitute the investment universe and to calculate a weight (or importance index) for the scoring indices.

In an embodiment, the machine learning unit 140 may cluster the investment assets into one or more asset classes depending on their attributes, and score the clustered asset classes to constitute the investment universe around investment assets with high scores. Here, the weight of the scoring indicator may be referenced.

In an embodiment, the machine learning unit 140 may use the CNN model to extract past dates most similar to current market conditions and price flows for the investment assets.

In an embodiment, the machine learning unit 140 may use a Monte Carlo algorithm to generate an expected chart model of the investment asset based on a chart related to the extracted past date. Here, the machine learning unit 140 may refer to past learning data and key financial indicators together with the chart related to the past date.

The rebalancing unit 150 compares the predicted chart flow with the actual market flow based on the predicted chart model generated by the machine learning unit 140 to see the flows are similar, and performs rebalancing according to the calculated investment portfolio. For example, when the predicted chart flow is similar to the actual market flow, the rebalancing unit 150 performs trading on actual investment assets depending on the expected buying and selling price and the trading time set based on the predicted chart. On the other hand, when the predicted chart flow is different from the actual market flow, e.g., when a gap between the predicted chart and the actual chart exceeds a certain standard, the rebalancing unit 150 resets the buying and selling price, the trading time, and the expected rate of return rate on the investment assets using the CNN model, and recalculates the risk and the investment portfolio thereof

In an embodiment, when the predicted chart flow is different from the actual market flow, the rebalancing unit 150 may perform counter-trading to reverse trading if the trading according to the existing prediction has already been performed. In other words, when the predicted chart flow is different from the actual market flow after buying investment assets according to the predicted chart flow, the rebalancing unit 150 may sell the previously purchased investment assets.

The monitoring unit 160 monitors the actual market flow and provides the rebalancing unit 150 with it. The monitoring unit 160 continuously monitors market flow, price change, transaction history, or the like until the market ends (or closes). The monitoring result of the monitoring unit 160 may be stored in the database 130 as market data.

In an embodiment, when the server 100 analyzes data collected from the outside and determines that financial risk, liquidity risk, legal risk, external bad news for individual investment assets, or bad news on similar other investment assets occurred, it may determine an investment reservation for the individual investment asset. Alternatively, when the server 100 analyzes the data collected from the outside and determines that a risk such as domestic and foreign politics or trade restriction has occurred for a specific industry group, it may reserve investments in investment assets belonging to the industry group. Alternatively, when the server 100 analyzes the data collected from the outside and determines that a risk such as international political issue, financial crisis, war, or natural disaster has occurred in the entire investment market, it may reserve investments in total investment assets.

In an embodiment, when the server 100 determines d that the predicted chart is similar to a chart showing a large drop in the past chart, it may reserve investment on the investment assets. Alternatively, the server 100 may reserve investment even when a theta of the predicted chart is lower than a predetermined level.

According to some embodiments of the present disclosure described above, a method and system are provided for managing entrusted dormant assets, in which the method and system utilize a machine learning-based AI to manage assets of a user's dormant account. It minimizes the manpower used for services to manage dormant assets. Therefore, it is possible to significantly lower administering costs, thereby lowering minimum investment. It is also possible to provide an asset management service at low fee.

Moreover, since the investment portfolio is calculated based on the investment propensity of individual users, and the investment universe and investment portfolio are constituted for a wide range of investment assets, it is possible to provide customized dormant asset management services similar to the existing WRAP accounts on a machine learning basis at low cost.

Further, since the entire process of investment and dormant asset management is automated by AI, it is possible to extract investment and dormant asset management status in real time and provide relevant information to the user. Therefore, it is possible to transparently disclose the dormant asset management status, and to secure reliability for the dormant asset management service.

In particular, the method for managing dormant assets in accordance with an embodiment of the present disclosure may greatly contribute to enabling investment of dormant assets in a simple procedure. For example, when a user with a dormant account signs up for the service through an app or a web, the server 100 according to an embodiment of the present disclosure may conveniently perform a series of procedures such as inquiry of the user's dormant account, termination of dormancy, and transferring assets of the dormant account to an administering account in connection with the account integration inquiry service through agreement of terms of use and personal information use agreement. Further, the server 100 may open a securities account for a user who does not have a securities account through information or authentication information of the user, and may provide the dormant asset management service in accordance with an embodiment of the present disclosure as a non-face-to-face agreement that a user does not have to visit a branch office.

According to the method for managing dormant assets, it is possible to bring about several positive changes in the discovery and utilization of individual dormant assets. The conventional account integration inquiry service is provided, but the amount of dormant assets still exceeds 300 billion won. According to the method for managing dormant assets in accordance with an embodiment of the present disclosure, it is possible to utilize the dormant assets of individuals very simply, thereby drastically reducing a size of assets that are not utilized in the dormant state. Further, the conventional general asset management services had the problem of being available to an investor who has large assets. However, according to the method for managing dormant assets in accordance with an embodiment of the present disclosure, even an investor who has small assets may use the service, so that the investor who has small assets may effectively utilize general dormant assets. Moreover, according to an embodiment of the present disclosure, the method for managing dormant assets leaves the entire process of dormant asset management to AI, thereby significantly reducing administering costs than existing asset management services. Therefore, it is possible to receive minimal administering fees and to return most of administering profits back to investors.

Hereinafter, a method for managing dormant assets based on the machine learning performed by the server 100 described with reference to FIGS. 1 and 2 will be described. Each step of the method for managing the dormant assets based on the machine learning described below may be implemented with one or more instructions executed by a processor of a computing device.

Here, an instruction means a series of computer readable instructions bounded by function, which are a component of a computer program and executed by the processor.

All steps included in the method for managing the dormant assets based on the machine learning may be executed by one physical computing device. However, it may be performed separately in a plurality of computing devices. In other words, a first step of the method is performed at a first computing device and a second step of the method is performed by a second computing device.

The method for managing the dormant assets based on the machine learning may be performed in various systems and/or environments. However, it will be described on the assumption of the environment illustrated in FIGS. 1 and 2 for convenience of understanding. Naturally, methods described below may be changed in order of operations within a range in which execution order may be logically changed.

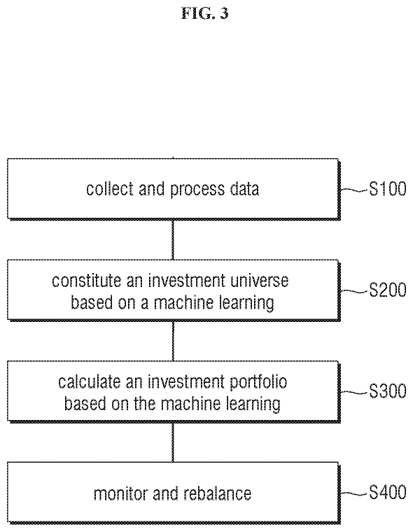

FIG. 3 is a flow chart showing a method for managing dormant assets based on machine learning, according to some embodiments of the present disclosure. Referring to FIG. 3, the method for managing dormant assets according to the present embodiment includes four steps of S100 to S400.

In step S100, a server 100 collects data from the outside and processes it. For example, the server 100 collects basic information, financial statements, electronic disclosure information, and equity information of a company by using a web crawler or a web mining technology, or collects company information through a news, blog or social network service (hereinafter, SNS). Alternatively, the server 100 may collect securities indexes (e.g., KOSPI Index, KOSDAQ Index, NASDAQ Index, Dow Index, Shanghai Index, Hang Seng Index, Nikkei Index, or the like), exchange rate indicators, oil price indicators, trading trends by investor, transaction details, market cap of stocks, trading volume, trading value, or short selling status using APIs provided by the market or securities companies, or may collect market data, such as investment alerts, investment warnings, suspension of trading, capital increase, dividends, or capital decease for certain stocks.

Then, the server 100 processes the collected data into secondary data for use in dormant asset management. For example, the server 100 may process numerical structured data of the collected data into the secondary data such as BPS (Book value Per Share), EPS (Earning Per Share), PER (Price Earning Ratio), PBR (Price Book value Ratio), ROE (Return On Equity), ROA (Return On Assets), RSI (Relative Strength Index), stochastics, moving average, market preference by theme, overall market indicator, market indicator by industry group, or volatility index. Alternatively, the server 100 may analyze non-numerical unstructured data of the collected data by using the SyntaxNex algorithm or a grab cut algorithm, or the like, and process them into the secondary data such as public expectations or fears about investment assets.

Data collected or processed by the server 100 may be stored in a database 130. The database 130 may be a database provided by an external cloud server.

In step S200, the server 100 constitutes an investment universe based on the machine learning. To this end, the server 100 may cluster investment assets into several asset classes by performing clustering on the investment assets according to predetermined criteria. For example, the server 100 may cluster the investment assets according to the predetermined criteria, such as theme, top 10% up and down, bottom 10% up and down, top 10% of trading volume, the market cap of each stage, undervalued stocks, high-valued stocks, top 10% expectations, or the like. Here, certain investment assets may belong to multiple asset classes.

Further, in order to calculate the investment universe, the server 100 determines a scoring indicator and calculates a weight (or importance index) of each scoring indicator. The weight is a value calculated to differentially reflect each scoring indicator depending on its importance. In an embodiment, the scoring indicator may include market cap, supply and demand, trading value and volume, chart analysis, or momentum indicator. In an embodiment, in order to calculate the weight, the server 100 may plot accumulated score data of the past and a rate of change of a day, and apply the same to a TensorFlow to calculate the weight of the scoring indicator.

When the weight is calculated, the server 100 performs the scoring for each asset class, and constitutes the investment universe with investment assets that obtain a higher score. In an embodiment, the server 100 may constitute the investment universe with top 200 investment assets with high scores.

In step S300, the server 100 calculates an investment portfolio for the investment assets constituting the investment universe. The server 100 uses a machine learning model (e.g., a CNN model) to compare today's price charts and historical cumulative price charts, change rates, supply and demand, trading volume, market liquidity indicators, market liquidity indicators in major countries, oil price indicator volatility, or exchange rate liquidity in major countries for the investment assets within the investment universe, and to extract a specific date in the past that most similar to a current market flow. Then, it extracts a price chart (e.g., a next day's price chart for a specific date) associated with the extracted specific date.

The server 100 generates an expected chart model by applying the Monte Carlo algorithm to past learning data and major financial indicators along with the extracted price chart. Then, the server 100 sets expected trading time, buying and selling price, or expected rate of return in the expected chart model, and calculates the risk of the investment assets by analyzing theta, volatility of the expected chart model, and the liquidity of key indicators from a specific date from which the expected chart is extracted.

The server 100 calculates an investment portfolio that includes the composition and weight of the investment assets and the total risk of the assets for a user's account by referring to the individual propensity of a user, such as the degree of investment knowledge of the user, the economic situation of the user, the target return rate of the user, or the investment sentiment of the user, based on the expected rate of return and risk predetermined or calculated.

In step S400, the server 100 monitors the actual market flow in real time, and compares the monitored flow with a predicted chart flow according to the predicted chart model generated earlier. Then, it refers to the comparison and performs rebalancing according to the calculated investment portfolio. Specifically, after the market is opened, the server 100 monitors the market in real time. Here, it uses the Monte Carlo algorithm to compare the predicted chart flow with the actual market flow.

In an embodiment, the server 100 may predict a chart based on remaining quotations, average trading volumes, chart flow, and chart flow of other investment assets clustered in the same asset class for the investment asset in the market, and may compare the results with the actual market flow.

When the predicted chart flow and the actual market flow are similar, the server 100 performs rebalancing to buy or sell the investment assets depending on the expected reasonable buying and selling price and timing of buying and selling. On the other hand, when the predicted chart flow differs from the actual market flow (for example, when there is a certain gap between the predicted chart flow and the actual market flow), it recalculates expected buying and selling price, timing, and expected rate of return using the CNN algorithm without performing rebalancing. Here, if it has already traded the investment assets, it may perform counter-trading.

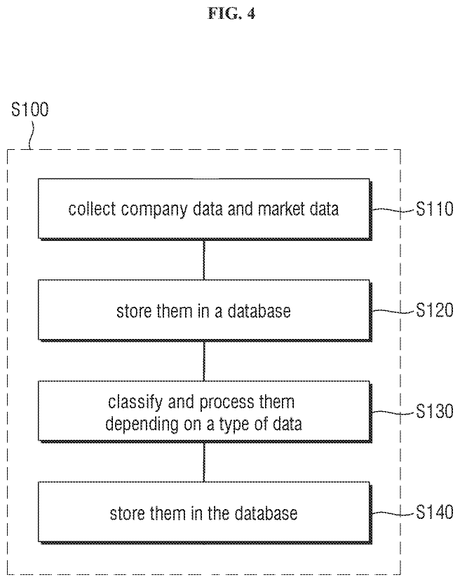

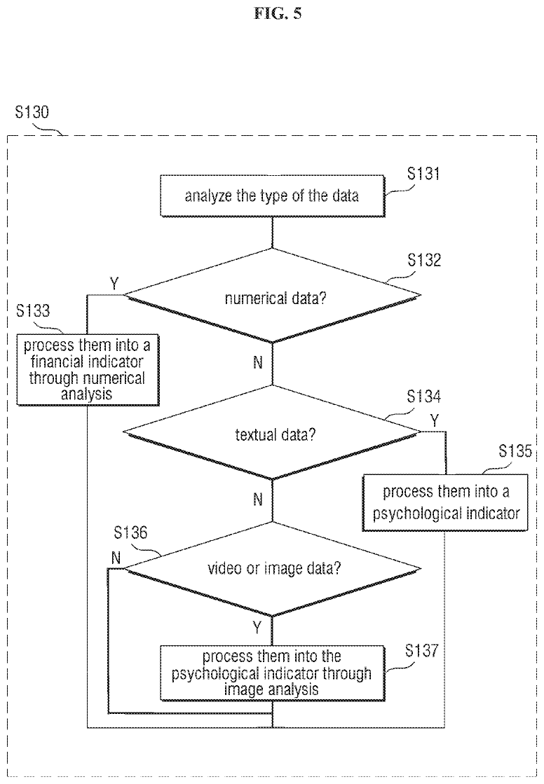

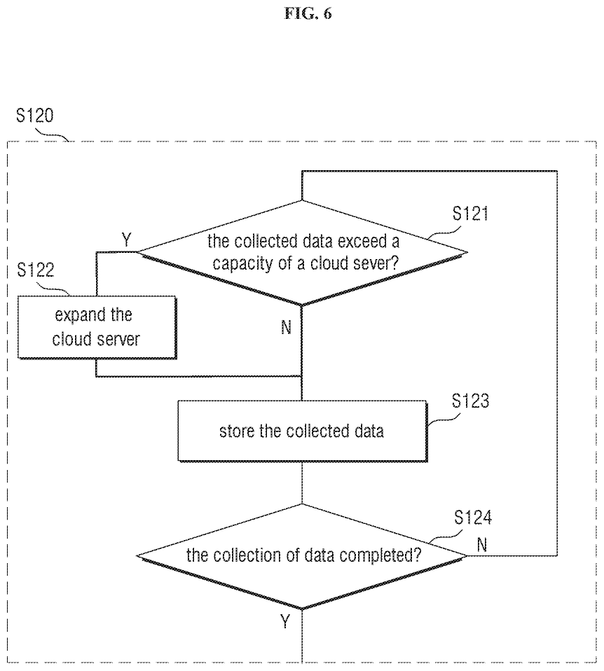

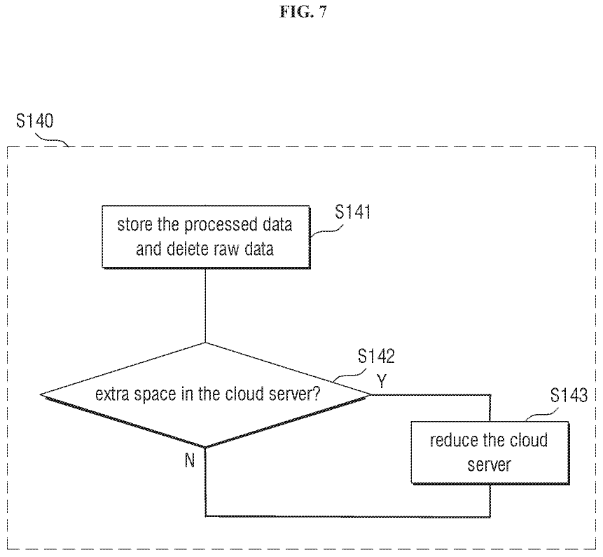

FIG. 4 is a flow chart further embodying the step of collecting and processing data, as shown in step S100 of FIG. 3. Referring to FIG. 4, step S100 may include four steps of steps S110 to S140. FIG. 5 is a flow chart embodying a method for scaling-up a cloud server, as described in step S120 of FIG. 4. FIG. 6 is a flow chart embodying the step of sorting and processing by a data type, as described in step S130 of FIG. 4. FIG. 7 is a flow chart embodying a method for scaling-down a cloud server, as described in step S140 of FIG. 4.

Hereinafter, step S100 will be described in detail with reference to FIGS. 4 to 7.

In step S110, the server 100 collects data about company information and data about market information using the web crawling, the web mining, or the API. Since the type of data collected by the server 100 and a method for collecting the same have been described in detail above, further description thereof will be omitted.

In step S120, the server 100 stores the collected data in the database 130. In the embodiment, it is assumed that the database 130 in which data is stored is a database provided by the external cloud server. When the capacity of the collected data is larger than the remaining capacity of the database 130, the server 100 may expand the database 130 to secure storage space (scale-up).

Referring to FIG. 5, specific steps of scale-up will be described. First, in step S121, the server 100 determines whether the collected data, i.e., the data to be stored in the database 130, exceeds the database capacity of the cloud server or exceeds the computing capability of the cloud server.

When it exceeds, the embodiment proceeds to step S122, and the server 100 will request to expand the cloud server. When the cloud server is expanded, the server 100 stores the collected data in the database (step S123).

On the other hand, when the collected data does not exceed the capacity of the cloud server, or the like, the embodiment proceeds directly to step S123 because the data may be stored using the capacity of the current cloud server.

In step S124, the server 100 determines whether data collection is completed. When the data collection is completed, it proceeds to the next step, S130. When the data collection is not completed, it returns to step S121 and continues to collect and store the data.

Returning to FIG. 4 again, in step S130, the server 100 classifies and processes the collected data depending on the type. Referring to FIG. 6, step S130 will be described in more detail.

In step S131, the server 100 analyzes a type of the collected data. This is because the means of processing the data and the results may vary depending on the type of the data. In step S132, the server 100 determines whether the type of the collected data is numerical structured data. When it is numerical structured data, the embodiment proceeds to step S133 to process the collected data into the financial indicators. For example, the server 100 may process the numerical structured data into the financial indicators such as BPS (Book value Per Share), EPS (Earning Per Share), PER (Price Earning Ratio), PBR (Price Book value Ratio), ROE (Return On Equity), ROA (Return On Assets), RSI (Relative Strength Index), stochastics, moving average, market preference by theme, overall market indicator, market indicator by industry group, or volatility index. When the collected data is not numerical structured data, the embodiment proceeds to step S134.

In step S134, the server 100 determines whether the collected data is textual unstructured data. When it is the textual unstructured data, the embodiment proceeds to step S135 to perform keyword analysis on the collected data and to provide the collected data into psychological indicators. Here, the server 100 may analyze emotional vocabulary words, motional adjectives, or the like included in the collected data by using the SyntaxNet algorithm, and process them into the psychological indicators such as expectation psychology, fear psychology, or the like. When the collected data is not textual unstructured data, the embodiment proceeds to step S136.

In step S134, the server 100 determines whether the collected data is image-type unstructured data. The image-type unstructured data may be a picture file, an image, or a video. When it is the image-type unstructured data, the embodiment proceeds to step S137 to perform image analysis on the collected data and to provide the collected data into the psychological indicators. Here, the server 100 may analyze the collected data by the grab cut algorithm and process the collected data into the psychological indicators such as the expectation psychology, the fear psychology, or the like. When the collected data is not the image-type unstructured data, the embodiment proceeds directly to step S140 without going through step S137.

Returning to FIG. 4 again, in step S140, the server 100 stores the processed data in the database 130. Here, when a surplus capacity exists in the database 130, scale-down may be performed to reduce it. The scale-down will be described in detail with reference to FIG. 7. In step S141, the server 100 stores the previously processed data in the database 130 and deletes original raw data used for the processing. For example, after the server 100 processes the collected data into the secondary data such as the financial indicators or the psychological indicators, the raw data collected for the first time has been used for its purpose and may be deleted. In step S142, the server 100 determines whether a surplus space exists in the cloud server. When the raw data is deleted as described above, the capacity of the database 130 may be increased. When there is the surplus space, the embodiment proceeds to step S143, and the server 100 requests the cloud server to reduce the surplus capacity in order to efficiently manage computing resources. When there is no surplus space, the embodiment proceeds directly without going through step S143.

FIG. 8 is a flow chart further illustrating the step of constituting an investment universe based on machine learning, as shown in step S200 of FIG. 3. Referring to FIG. 8, step S200 includes four steps of steps S210 to S240.

In step S210, the server 100 clusters (groups) the investment assets into one or more asset classes depending on characteristics of the assets. For example, the server 100 may cluster the investment assets in to one or more asset classes according to the predetermined criteria, such as the theme, the top 10% up and down, the bottom 10% up and down, the top 10% of trading volume, the market cap of each stage, the undervalued stocks, the high-valued stocks, the top 10% expectations, or the like. Here, certain investment assets may belong to multiple asset classes.

In step S220, the server 100 sets the scoring indicator and calculates the weight for each scoring indicator based on the machine learning. Here, the scoring indicator may include the market cap, the supply and demand, the trading value and volume, the chart analysis, or the momentum indicator. The weight is calculated to reflect each scoring indicator differentially depending on its importance. In order to calculate the weight, the server 100 may plot the accumulated score data of the past and the rate of change of the day, and apply the same to the TensorFlow to calculate the weight of the scoring indicator.

In step S230, the server 100 proceeds scoring for each asset class. Once the weight for the scoring indicator is calculated, the server 100 may carry out scoring depending on the scoring indicator for the investment asset. The server 100 measures individual scores for each of the clustered asset classes and aggregates the weights of the indicators and the individual scores to carry out overall scoring on the asset classes.

In step S240, the server 100 constitutes the investment universe with the investment assets that obtain the higher score depending on the scoring result. In an embodiment, the server 100 may constitute the investment universe with top 200 investment assets with high scores.

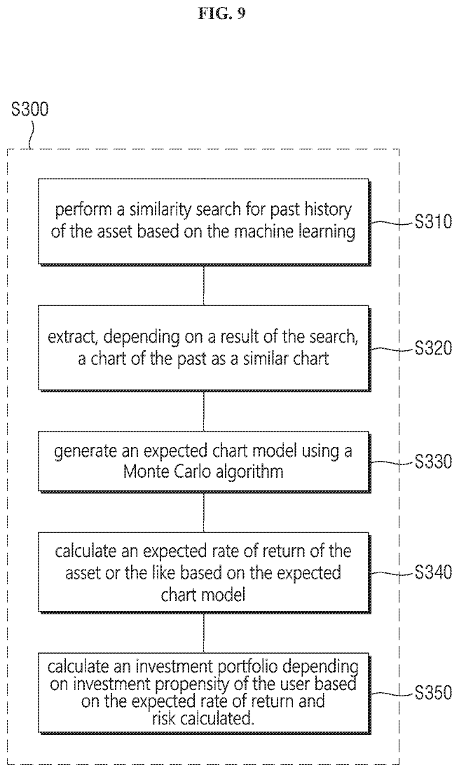

FIG. 9 is a flow chart further embodying the step of calculating an investment portfolio based on machine learning, as shown in step S300 of FIG. 3. Referring to FIG. 9, step S300 includes five steps of steps S310 to S350.

In step S310, the server 100 performs a similarity search for past history of the asset based on the machine learning. Specifically, the server 100 compares today's minute chart and historical cumulative minute chart, fluctuation rate, supply and demand, trading value, KOSPI liquidity indicator, major national securities liquidity indicator, oil price indicator volatility, or major country exchange rate liquidity for investment assets within the investment universe, and uses the machine learning model (e.g., the CNN model) to perform the similarity search that extracts a specific date in the past that is most similar to the current market situation and the price flow of the asset as a base date.

In step S320, the server 100 extracts a chart related to a specific date (i.e., a reference date) of the past extracted according to the search result as a similar chart. In an embodiment, the server 100 may extract a minute chart of the next day of the specific date as the similar chart.

In step S330, the server 100 generates the expected chart model using the Monte Carlo algorithm. In an embodiment, the server 100 may generate the expected chart model by applying the Monte Carlo algorithm to the minute chart of the next day previously extracted as the similar chart, past learning data, and major financial indicators.

In step S340, the server 100 calculates or sets the expected rate of return of the asset or the like based on the expected chart model, and calculates risk accordingly. For example, the server 100 may calculate the risk of the investment assets by calculating or setting the expected buying and selling price, the timing of buying and selling, and the expected rate of return from the expected chart model, and by analyzing the major indicator liquidity of a date when theta, volatility, and the expected chart model are extracted.

In step S350, the server 100 calculates the investment portfolio in consideration of the investment propensity of the user, together with the expected rate of return and the risk set or calculated. The server 100 calculate the investment portfolio which includes target asset composition, weight ratio, and total risk of the asset depending on the investment propensity of the user, which is obtained by analyzing the user's investment knowledge, economic situation, target rate of return, investor sentiment or the like, based on the expected rate of return and the risk. Here, information such as the investment knowledge, the economic situation, the target rate of return, the investment sentiment, or the like of the user may be information provided from the user when the asset management service according to the present disclosure is requested.

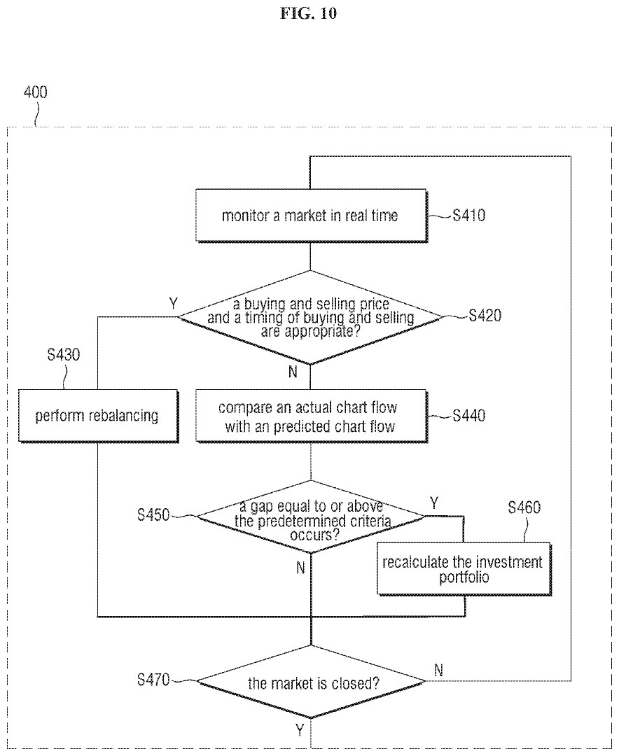

FIG. 10 is a flow chart further embodying the step of monitoring and rebalancing, as shown in step S400 of FIG. 3. Referring to FIG. 10, step S400 includes seven steps of steps S410 to S470.

In step S410, the server 100 monitors the market in real time. The market monitoring may be performed using the API provided by the securities companies or a market server.

In step S420, the server 100 determines whether the buying and selling price and the timing of buying and selling depending on the current market flow are appropriate compared with the predicted result. When the buying and selling price and the timing of buying and selling are appropriate, the embodiment proceeds to step S430. Otherwise, the embodiment proceeds to step S440.

In step S430, the server 100 performs rebalancing to trade actual investment assets depending on the predicted buying and selling price and the trading time. When the rebalancing is completed, the embodiment proceeds to step S470.

In step S440, the server 100 compares the actual chart flow with the predicted chart flow based on the expected chart model. Then, it determines whether the actual chart flow is similar to or different from the predicted chart flow. Here, the server 100 may compare the previously predicted chart flow with the actual chart flow through the Monte Carlo algorithm. Here, it may predict the chart based on the quoted balance, the average trading volume, and the chart flow of the investment asset, or the chart flow of other investment assets in the same asset class.

In step S450, the server 100 determines whether a gap equal to or above the predetermined criteria occurs between the actual chart flow and the predicted chart flow. When the gap equal to or above the predetermined criteria has occurred, the present embodiment proceeds to step S460. Otherwise, the embodiment proceeds to step S470.

In step S460, the server 100 recalculates the investment portfolio. In other words, since the predicted chart flow and the actual market flow are different, the server 100 recalculates the investment portfolio in line with the market flow. Here, when the trading has already been made, the server 100 may perform the counter-trading to reverse it. For example, when it has already bought an investment, it may revert by selling it again. The server 100 calculates the expected buying and selling price, the timing of buying and selling, and the expected rate of return using the CNN model, and performs to recalculate the portfolio accordingly.

In step S470, the server 100 determines whether the market is closed. When the market has ended, the embodiment may end. Otherwise, the embodiment returns to step S410 to monitor the market again in real time.

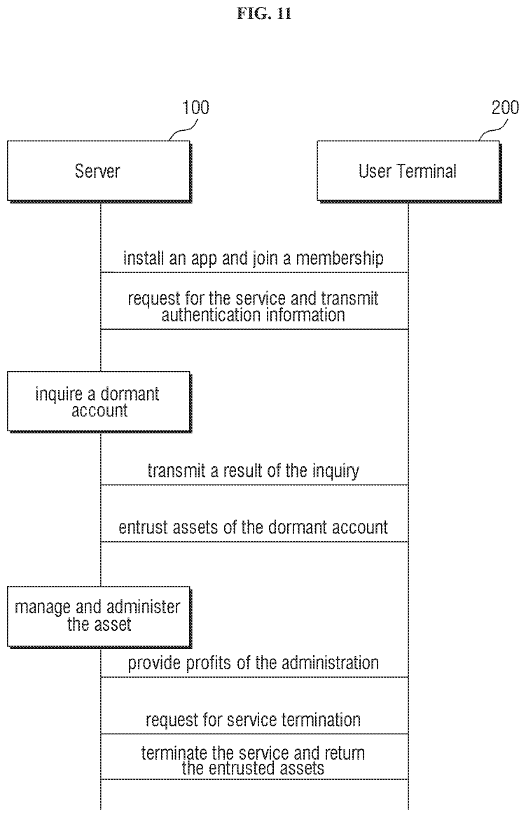

FIG. 11 is a flow chart exemplifying a method for managing assets based on machine learning, according to some embodiments of the present disclosure. In an example of a specific business model to which the method for the managing dormant assets based on the machine learning applies of the embodiment, a user's dormant account is inquired and assets of the dormant account are entrusted and administered with the user's consent. The method may be applied to administer a user account associated with an account in which the dormant state has been released or in which deposit of the dormant account has been transferred.

Referring to FIG. 11, first, an application (APP) provided by an operator of a server 100 may be installed in a user terminal 200, and one may request membership in the server 100 through the APP. However, this is one embodiment, and installation of the application and a membership request through it are not necessarily required. Then, the user terminal 200 requests a dormant asset management service according to the present embodiment to the server 100 and transmits user authentication information for the same.

In response to the service request from the user terminal 200, the server 100 inquires the user's dormant account using the provided user authentication information. Then, the server 100 transmits the result of inquiring the dormant account to the user terminal 200. In an embodiment, the server 100 may inquire the dormant account in connection with an account integration inquiry service using the authentication information of the user. The user sees the transmitted inquiry result and requests the server 200 to entrust the asset of the dormant account through the user terminal 200.

In response to a request from the user terminal 200, the server 100 entrusts and administers the assets of the user's dormant account. Here, the method for managing assets according to some embodiments described above is used as a specific method for the server 100 to manage and administer the assets of the dormant account. In other words, the server 100 manages and administers the assets of the dormant account using a series of methods that collects and processes financial information and company information, constitutes an investment universe based on the machine learning, calculates expected rate of return and risk using similarity search and the Monte Carlo algorithm, generates an investment portfolio that reflects the user's propensity to invest, monitors market flow, and rebalances it accordingly. Then, when it manages and administers the assets of the dormant accounts and generates revenue from them, the server 100 provides administration revenue to the user. In an embodiment, the server 100 terminates the user's dormant account in connection with the account integration inquiry service and transfers the assets of the dormant account to an account administered by the server 100, thereby managing and administering the assets of the user's dormant account. In an embodiment, when there is no securities account held by the user, the server 100 may open a securities account of the user in connection with a securities company and may administer dormant assets of the user through the opened securities account. Here, the opening of the user's securities account may be automatically performed by the server 100 using authentication information or consent of the user.

On the other hand, when the user wants to terminate the entrusted management and administration service of the dormant account assets according to the present embodiment, the user may transmit a service termination request through the user terminal 200. In response to the service termination request, the server 100 terminates the service and returns the entrusted asset to the user.

According to the embodiment above, the user may invest the dormant asset in a simple procedure. The method for managing the dormant assets according to the embodiment has a low minimum investment limit, so that small dormant depositors may easily invest their assets. Further, it is possible to actively induce dormant assets that have been left inefficiently to the financial market and contribute to the vitalization of the financial industry.

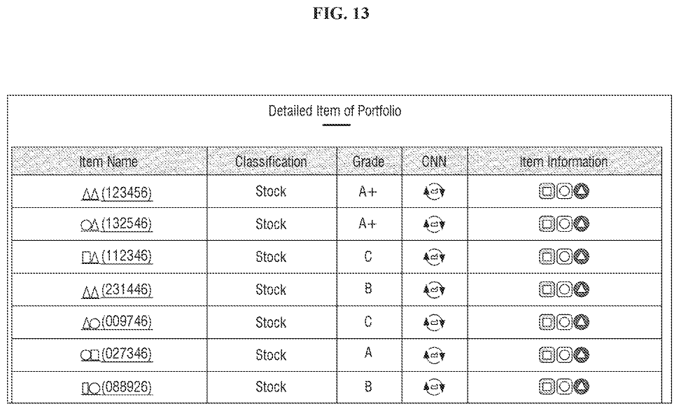

FIGS. 12 and 13 illustrate an application UI used in a method for managing dormant assets based on machine learning, in accordance with some embodiments of the present disclosure. FIGS. 12 and 13 merely show examples of application of the UI for clarity of understanding. The scope of the present disclosure is not limited thereto, and various modified UIs may be applied to the method for managing the dormant assets according to an embodiment of the present disclosure.

Referring to FIG. 12, there is shown an interface through which a user may set his/her investment propensity. For example, the user may change the investment propensity reflected in the method for manage the assets according to the embodiment of the present disclosure by selecting whether his/her investment propensity is “an aggressive type” or “a stable type” in an item “administration type.” If the user selects his/her investment propensity as “the aggressive type,” the server 100 will constitute the user's investment portfolio in a way that expects higher returns with higher investment risk. On the other hand, if the user selects his/her investment propensity as “the stable type,” the server 100 will constitute the user's investment portfolio to the extent that the investment risk is not too high. Alternatively, the user may also change a value of an item “loss cut.” If the user have a strong short-term investment propensity, he/she might want to change the value of his/her loss cut lower (e.g. -5%), and if the user have a strong long-term investment propensity, he/she might want to change the value of his/her loss cut higher (e.g. −30%).

Referring to FIG. 13, an interface for allowing the user to check his/her portfolio in real time is provided. An item “item name” displays a list of investments that constitutes his/her portfolio. An item “classification” displays a type of investment assets (e.g. whether it is a stock, bond, or the like). An item “grade” may display a grade of the investment assets, for example, a scoring result of individual assets according to a method for scoring of the present disclosure. An item “CNN” may display the results of similarity search based on the machine learning. A link for providing information on the investment assets may be provided in an item “item information.”

Finally, an example computing device that may implement a device according to various embodiments of the present disclosure will be described with reference to FIG. 14.

FIG. 14 is a hardware diagram illustrating a computing device 2000. As shown in FIG. 14, the computing device 2000 may include one or more processors 2100, a memory 2200 for loading a computer program executed by the processor 2100, a bus 2500, a communication interface 2400, and a storage 2300 for storing a computer program 2310. FIG. 14 illustrates components related to an embodiment of the present disclosure. Accordingly, it will be appreciated by those skilled in the art that the present disclosure may further include other general purpose components in addition to the components illustrated in FIG. 14.

The processor 2100 controls the overall operation of each component of the computing device 2000. The processor 3100 may include a central processing unit (CPU), a microprocessor unit (MPU), a micro controller unit (MCU), a graphics processing unit (GPU), or any type of processor well known in the art. In addition, the processor 2100 may perform an operation on at least one application or program for executing a method/operation according to embodiments of the present disclosure. The computing device 2000 may have one or more processors.

The memory 2200 stores various data, commands, and/or information. The memory 2200 may load one or more programs 2310 from the storage 2300 to execute a method/operation according to various embodiments of the present disclosure. The memory 2200 may be implemented as a volatile memory such as a RAM, but the technical scope of the present disclosure is not limited thereto.

The bus 2500 provides communication between components of the computing device 2000. The bus 2500 may be implemented as various types of buses such as an address bus, a data bus, a control bus, or the like.

The communication interface 2400 supports wired and wireless Internet communication of the computing device 2000. In addition, the communication interface 2400 may support various communication methods other than Internet communication. To this end, the communication interface 2400 may comprise a communication module well known in the art. In some cases, the communication interface 2400 may be omitted.

The storage 2300 may non-temporarily store one or more computer programs 2310, various data (e.g., a set of learning data), a machine learning model, or the like. The storage 2300 may include a non-volatile memory such as a read only memory (ROM), an erasable programmable ROM (EPROM), an electrically erasable programmable ROM (EEPROM), or a flash memory, a hard disk, a removable disk, or any form of computer readable recording medium well known in the art to which the present disclosure belongs.

The computer program 2310 may include one or more instructions that, when loaded into memory 2200, cause the processor 2100 to perform methods/operations according to various embodiments of the present disclosure. In other words, the processor 2100 may perform the methods/operations according to various embodiments of the present disclosure by executing the one or more instructions.

For example, the computer program 2310 may include instructions for performing an operation to collect and process the financial information and the company information, an operation to constitute the investment universe based on the machine learning accordingly, an operation to calculate the expected rate of return or the risk using the similarity search and the Monte Carlo algorithm, an operation to calculate the investment portfolio reflecting the user's investment propensity, and an operation to monitor the market flow and rebalance accordingly.

Various embodiments of the present disclosure and effects according to the embodiments have been described with reference to FIGS. 1 to 14. Effects according to the spirit of the present disclosure are not limited to the above-mentioned effects, and other effects not mentioned will be clearly understood by those skilled in the art from the following description.

The technical spirit of the present disclosure described with reference to FIGS. 1 to 14 may be implemented as computer readable codes on a computer readable medium. The computer-readable recording medium may be, for example, a removable recording medium (CD, DVD, Blu-ray disc, USB storage device, removable hard disk) or a fixed recording medium (ROM, RAM, computer equipped hard disk). The computer program recorded on the computer-readable recording medium may be transmitted to other computing device a network such as the Internet and installed in the other computing device, thereby being used in the other computing device.

In the above description, it is described that all components constituting the embodiments of the present disclosure are combined or operated in one, but the technical spirit of the present disclosure is not limited to the embodiments. In other words, within the scope of the present disclosure, all of the components may be selectively operated in combination with one or more.

Although the operations are shown in a particular order in the drawings, it should not be understood that the operations must be performed in the specific order or sequential order shown or that all the illustrated operations must be executed to achieve the desired results. In certain circumstances, multitasking and parallel processing may be advantageous. Moreover, the separation of the various configurations in the embodiments described above should not be understood as such separation being necessary. It should be understood that the described program components and systems may generally be integrated together into a single software product or packaged into multiple software products.

Although the embodiments of the present disclosure have been described with reference to the accompanying drawings, it may be understood that they may be embodied in other specific forms without departing from the spirit and essential features of those skilled in the art. Therefore, it is to be understood that the embodiments described above are exemplary in all respects and not restrictive. The scope of protection of the present disclosure should be construed by the following claims, and all technical spirit within the scope equivalent thereto shall be construed as being included in the scope of the technical spirit defined by the present disclosure.

What is claimed is:

1. A method for managing assets based on machine learning, wherein the method is performed by a computing device, the method comprising:
performing a similarity search for past history of the assets based on the machine learning;
determining a reference date for extracting a similar chart depending on a result of the similarity search; and
extracting the similar chart depending on the determined reference date and generating an expected chart model based on the similar chart.

2. The method of claim 1, wherein the expected chart model is generated using a Monte Carlo algorithm.

3. The method of claim 1, further comprising:
calculating an expected rate of return and a risk of the assets depending on the expected chart model; and
calculating, based on the expected rate of return and the risk which are calculated, an investment portfolio based on a user's investment propensity.

4. The method of claim 3, wherein the risk is calculated by referring to theta and volatility of the predicted chart model, or indicator liquidity of the reference date.

5. The method of claim 3, further comprising:
constituting an investment universe for calculating the investment portfolio,
wherein constituting the investment universe comprises:
clustering the assets into one or more asset classes;
scoring for each of the asset classes; and
determining, depending on a result of the scoring, assets that is to constitute the investment universe among the asset classes.

6. The method of claim 5, wherein scoring for each of the asset classes comprises:
calculating weights for one or more scoring indicators: and
scoring for the one or more asset classes with reference to the calculated weights.

7. The method of claim 1, further comprising:
collecting data to be provided to the machine learning,
wherein collecting the data comprises collecting company information or market information related to the assets by using web crawling, web mining, or API.

8. The method of claim 7, further comprising:
storing the collected data,
wherein storing the collected data comprises requesting expansion of a database based on a capacity of the collected data exceeds a capacity of the database.

9. The method of claim 7, further comprising:
processing the collected data,
wherein processing the data comprises:
analyzing a type of the data; and
processing, depending on a result of analyzing the type, the data into a financial indicator or a psychological indicator.

10. The method of claim 9, further comprising:
storing the processed financial indicator or psychological indicator in a database,
wherein storing comprises requesting a reduction of the database based on excess space in the database.

11. The method of claim 1, further comprising:
monitoring a market where the assets are traded and rebalancing where the assets are bought and sold depending on a result of the monitoring.

12. The method of claim 11, wherein rebalancing comprises:
determining whether a buying and selling price and a buying and selling timing of the assets are appropriate; and
performing, depending on a result of the determining, rebalancing that buys and sells the asset.

13. The method of claim 11, wherein rebalancing comprises:
determining whether a buying and selling price and a buying and selling timing of the assets are appropriate;
comparing, depending on a result of the determining, a predicted chart flow based on the expected chart model with an actual chart flow of the market; and
calculating, depending on a result of the comparing, the expected rate of return and the risk of the assets based on the expected chart model.

14. The method of claim 1, wherein asset administration for a user account is performed with reference to the expected chart model generated, the user account being an account that has been released from dormancy or an account associated with an account to which deposit of the account that has been released from dormancy is transferred.

15. A system for managing assets comprising:
a memory for storing one or more instructions; and
a process, wherein the process performs a similarity search for past history of the assets based on machine learning, determines a reference date for extracting a similar chart depending on a result of the similarity search, and extracts the similar chart depending on the determined reference date and generates an expected chart model based on the similar chart, by executing the stored one or more instructions.
